(19) United States
(12) Patent Application Publication
(10) Pub. No.: US 2017/0163490 A1
(43) Pub. Date: Jun. 8, 2017

(54) METHOD AND DEVICE FOR DETECTING HOTLINKING

(71) Applicants: Le Holdings (Beijing) Co., Ltd., Beijing (CN); LeCloud Computing Co., Ltd., Beijing (CN)

(72) Inventors: Fan WEI, Beijing (CN); Ming LI, Beijing (CN)

(21) Appl. No.: 15/246,479

(22) Filed: Aug. 24, 2016

Related U.S. Application Data
(63) Continuation of application No. PCT/CN2016/088877, filed on Jul. 6, 2016.

(30) Foreign Application Priority Data
Dec. 7, 2015 (CN) 201510890274.7

(51) Int. Cl. H04L 12/24; H04L 29/08; H04L 29/06

(52) U.S. Cl. CPC H04L 41/12; H04L 67/42; H04L 67/10; H04L 67/32

(57) ABSTRACT

Disclosed are a method and a device for detecting hotlinking. The method includes: receiving a resource obtaining request for obtaining a resource sent from a client, wherein identification information of the client is carried in the resource obtaining request; determining whether there is feature identification information in the identification information of the client, wherein the feature identification information is configured to indicate that there is advertising information which is associated with the resource requested by the resource obtaining request and is delivered to the client; and if there is the feature identification information, sending the resource corresponding to the resource obtaining request to the client.

### CROSS REFERENCE TO RELATED APPLICATIONS

This application is a continuation of International Application No. PCT/CN2016/088877, filed on Jul. 6, 2016, which is based upon and claims priority to Chinese Patent Application No. 201510890274.7, filed on De. 7, 2015, the entire contents of which are incorporated herein by reference.

### TECHNICAL FIELD

The present disclosure relates to information technologies, and more particularly, to a method and a device for detecting hotlinking.

### BACKGROUND

With developments of information technologies, more and more people use networks to obtain various desired resources. Accordingly, more and more network security problems emerge. Hotlinking is one of the most common security problems. Hotlinking is an action as follows. For example, when a server associated with a website receives a resource request sent from a user, the resource request can be copied by malicious third parties or unauthorized users, and then the malicious third parties or unauthorized users deliver the copied resource request to a plurality of other unauthorized users. Then these unauthorized users can access the resources on the website, thereby resulting in wastes of resources on the website.

Because of the large number of users who are using resources, there is no effective method at present to verify identifies of access users, and thereby detection of hotlinking cannot be realized. As a result, a lot of unauthorized users do hotlinking actions, which causes loss of data and resources on websites and wastes of system resources.

### SUMMARY

The present disclosure provides a method and a device for detecting hotlinking so as to solve the problem that because there is no effective method to verify identifies of access users and thereby detection of hotlinking cannot be realized, a lot of unauthorized users do hotlinking actions, which causes loss of data and resources on websites and wastes of system resources.

In a first aspect, embodiments of the present disclosure provide a method for detecting hotlinking, implemented by a resource server, including:

receiving a resource obtaining request for obtaining a resource sent from a client, wherein identification information of the client is carried in the resource obtaining request;

determining whether there is feature identification information in the identification information of the client, wherein the feature identification information is configured to indicate that there is advertising information which is associated with the resource requested by the resource obtaining request and is delivered to the client; and

if there is the feature identification information, sending the resource corresponding to the resource obtaining request to the client.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for detecting hotlinking mentioned by embodiments of the present disclosure.

In a third aspect, embodiments of the present disclosure provide a non-transitory computer-readable storage medium storing executable instructions that, when executed by an electronic device, cause the electronic device to perform any methods for detecting hotlinking mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for detecting hotlinking in accordance with some embodiments.

FIG. 2 is a flow chart of another method for detecting hotlinking in accordance with some embodiments.

FIG. 3 is a block diagram of a device for detecting hotlinking in accordance with some embodiments.

FIG. 4 is a block diagram of another device for detecting hotlinking in accordance with some embodiments.

FIG. 5 is a block diagram of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

An embodiment of the present disclosure provides a method for detecting hotlinking. As shown in FIG. 1, the method can be applied in a resource server and can include the following steps.

In 101, a resource server receives a resource obtaining request for obtaining a resource sent from a client.

Identification information of the client is carried in the resource obtaining request. The identification information of the client is configured to identify the client. Identification information of the resource requested by the obtaining request or a link address corresponding to the resource can be carried in the resource obtaining request, so that the server can obtain the resource according to the identification information and send the resource to the client. The identification information of the client can include a login account, a visitor account and so on, and embodiments of the present disclosure do not impose specific limitations on this.

In 102, the resource server determines whether there is feature identification information in the identification information of the client.

The feature identification information is configured to indicate that there is advertising information which is associated with the resource requested by the resource obtaining request and is delivered to the client. For example, if the requested resource is a film, the advertising information associated with the resource can include the poster of the film, the summary of the film, reviews for the film and the like, and embodiments of the present disclosure do not impose specific limitations on this. The feature identification information can be Token information assigned by the advertising system, and embodiments of the present disclosure do not impose specific limitations on this.

In 103, if there is the feature identification information, the resource server sends the resource corresponding to the resource obtaining request to the client.

In embodiments of the present disclosure, if there is the feature identification information in the identification information of the client, for example, if a user requests a resource which is a film and the clients delivers advertising information relating to the film, such as the poster of the film, the summary of the film, reviews for the film and the like, it is indicated that the user is really interested in the film. For those unauthorized users who are only interested in the resource corresponding to the film, the advertising information is not delivered. In this way, the resource corresponding to the resource obtaining request is sent to the client only if there is the feature identification information in the identification information of the client, and thus a verification on the user who requests the resource is realized. This can ensure that the user who requests the resource is the one who really needs this resource rather than those doing hotlinking. Consequently, loss of data and resources on websites and wastes of system resources can be avoided.

In the method for detecting hotlinking provided by the present disclosure, firstly, a resource obtaining request for obtaining a resource sent from a client is obtained, and identification information of the client is carried in the resource obtaining request; then, whether there is feature identification information in the identification information of the client is determined, and the feature identification information is configured to indicate that there is advertising information which is associated with the resource requested by the resource obtaining request and is delivered to the client; if there is the feature identification information, the resource corresponding to the resource obtaining request is sent to the client. In conventional technologies, because of the large number of users who are using resources, there is no effective method at present to verify identifies of access users and thereby detection of hotlinking cannot be realized. As compared with the conventional technologies, the technical solutions in embodiments of the present disclosure configure the feature identification information associated with resources to be accessed for users in advance, and perform verification when users request the resources, and thus can ensure that the users who request resources are those who really need these resources rather than those doing hotlinking. Consequently, loss of data and resources on websites and wastes of system resources can be avoided.

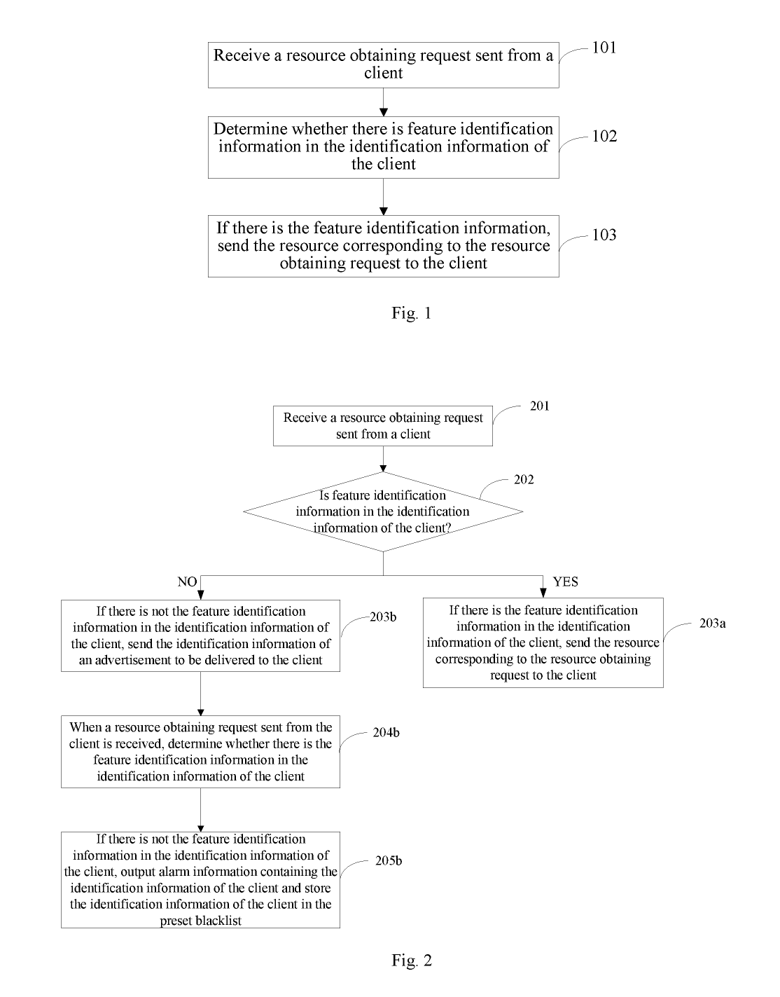

Correspondingly to the above method, an embodiment of the present disclosure provides another method for detecting hotlinking. As shown in FIG. 2, the method can be applied in a resource server and can include the following steps.

In 201, a resource server receives a resource obtaining request for obtaining a resource sent from a client.

Identification information of the client is carried in the resource obtaining request. The identification information of the client is configured to identify the client. Identification information of the resource requested by the obtaining request or a link address corresponding to the resource can be carried in the resource obtaining request, so that the server can obtain the resource according to the identification information and send the resource to the client. The identification information of the client can include a login account, a visitor account and so on, and embodiments of the present disclosure do not impose specific limitations on this.

In 202, the resource server determines whether there is feature identification information in the identification information of the client.

The feature identification information is configured to indicate that there is advertising information which is associated with the resource requested by the resource obtaining request and is delivered to the client. For example, if the requested resource is a ball game, the advertising information associated with the resource can include description about teams, the kick-off time, sell advertisements for team shirts and the like, and embodiments of the present disclosure do not impose specific limitations on this. The feature identification information can be Token information assigned by the advertising system, and embodiments of the present disclosure do not impose specific limitations on this.

In the embodiment of the present disclosure, before step 202, the method may further include: determining whether there is the identification information of the client in a preset blacklist. The preset blacklist records identification information of users who have been determined as unauthorized users. The determining of unauthorized users can be performed based on historical experiences, or by detecting in real time, and embodiments of the present disclosure do not impose specific limitations on this. Step 202 can include: if there is not the identification information of the client in the preset blacklist, determining whether there is the feature identification information in the identification information of the client; and if there is identification information of the client in the preset blacklist, stopping any operations and responses to the identification information of the client. In the embodiment of the present disclosure, if it is determined that the identification information of the client which sends the resource obtaining request is included in the preset blacklist, it is indicated that the client is an unauthorized client, and the resource server will not perform identity verification. This can further increase hotlinking detection efficiency.

In 203a, if there is the feature identification information in the identification information of the client, the resource server sends the resource corresponding to the resource obtaining request to the client.

In embodiments of the present disclosure, if there is the feature identification information in the identification information of the client, for example, if a user requests a resource which is a ball game and the clients delivers advertising information relating to the resource, such as description about teams, the kick-off time, sell advertisements for team shirts and the like, it is indicated that the user is really interested in the ball game. For those unauthorized users who are only interested in the resource corresponding to the ball game, the advertising information is not delivered. In this way, the resource corresponding to the resource obtaining request is sent to the client only if there is the feature identification information in the identification information of the client, and thus verification on the user who requests the resource is realized. This can ensure that the user who requests the resource is the one who really needs this resource rather than those doing hotlinking. Consequently, loss of data and resources on websites and wastes of system resources can be avoided.

In 203b, which is in parallel with step 203a, if there is not the feature identification information in the identification information of the client, the resource server sends the identification information of an advertisement to be delivered to the client.

By doing this, the client can obtain the advertisement from an advertising system according to the identification information of the advertisement to be delivered, deliver the advertisement, and receive the feature identification information sent from the advertising system. For example, challenge information can be sent to the client, and then the client sends the challenge information to the advertising system. At this time, the advertising system sends response information, in which Token information is carried, to the client, and delivers the advertisement corresponding to the client. Thus, the delivering of the advertisement and assignment of the feature identification information are finished.

After 203b, in step 204b, when a resource obtaining request sent from the client is received, the resource server determines whether there is the feature identification information in the identification information of the client.

In the embodiment of the present disclosure, after the feature identification information is assigned for the client, whether there is the feature identification information in the identification information of the client is determined again. In this way, the resource server can determine whether the client does not include the feature identification information in the first resource obtaining request because no feature identification information is assigned before and thereby determine whether the user is an unauthorized user who is only interested in the resource per se.

After step 204b, in step 205b, if there is not the feature identification information in the identification information of the client, the resource server outputs alarm information containing the identification information of the client and stores the identification information of the client in the preset blacklist.

For example, the alarm information can include text information, audio information, video information and the like, and embodiments of the present disclosure do not impose specific limitations on this. In the embodiment of the present disclosure, if the obtaining manner for the feature identification information is provided to the client, but the resource obtaining request sent by the client still does not contain the feature identification information, it is indicated that the client is an unauthorized one which is only interested in the resource per se. At this time, by outputting the alarm information, the unauthorized client can be processed in time, and the identification information of the client can be stored in the preset blacklist. This can realize an active protection against hotlinking and thereby further improve the security of the system resources.

In the method for detecting hotlinking provided by the present disclosure, firstly, a resource obtaining request for obtaining a resource sent from a client is obtained, and identification information of the client is carried in the resource obtaining request; then, whether there is feature identification information in the identification information of the client is determined, and the feature identification information is configured to indicate that there is advertising information which is associated with the resource requested by the resource obtaining request and is delivered to the client; if there is the feature identification information, the resource corresponding to the resource obtaining request is sent to the client. In conventional technologies, because of the large number of users who are using resources, there is no effective method at present to verify identifies of access users and thereby detection of hotlinking cannot be realized. As compared with the conventional technologies, the technical solutions in embodiments of the present disclosure configure the feature identification information associated with resources to be accessed for users in advance, and perform verification when users request the resources, and thus can ensure that the users who request resources are those who really need these resources rather than those doing hotlinking. Consequently, loss of data and resources on websites and wastes of system resources can be avoided.

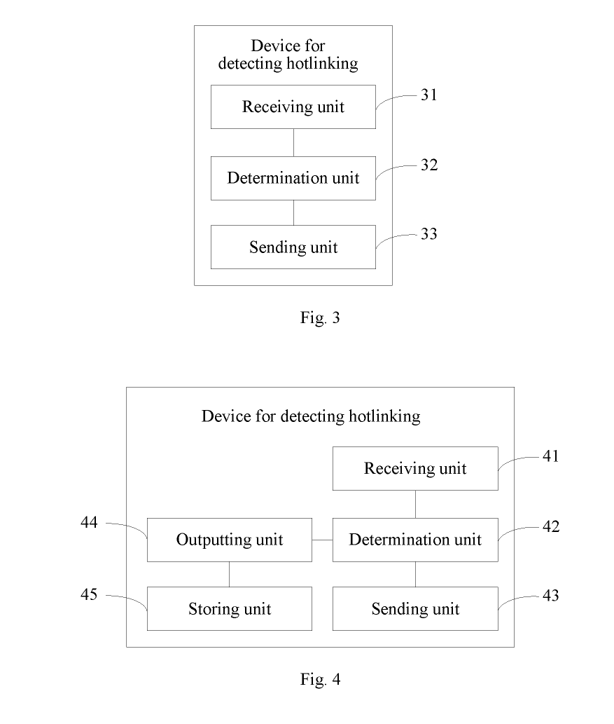

Further, an embodiment of the present disclosure provides a device for detecting hotlinking to implement the above method described in connection with FIG. 1. The device can be arranged in a resource server. As shown in FIG. 3, the device can include a receiving unit 31, a determination unit 32, and a sending unit 33.

The receiving unit 31 is configured to receive a resource obtaining request for obtaining a resource sent from a client. Identification information of the client is carried in the resource obtaining request.

The determination unit 32 is configured to determine whether there is feature identification information in the identification information of the client. The feature identification information is configured to indicate that there is advertising information which is associated with the resource requested by the resource obtaining request and is delivered to the client.

The sending unit 33 is configured to, if there is the feature identification information, send the resource corresponding to the resource obtaining request to the client.

It should be noted that the above descriptions in connection with FIG. 1 also apply to respective functional units in the device for detecting hotlinking provided in the embodiment of the present disclosure, and thus repeated description is omitted.

In the device for detecting hotlinking provided by the present disclosure, firstly, a resource obtaining request for obtaining a resource sent from a client is obtained, and identification information of the client is carried in the resource obtaining request; then, whether there is feature identification information in the identification information of the client is determined, and the feature identification information is configured to indicate that there is advertising information which is associated with the resource requested by the resource obtaining request and is delivered to the client; if there is the feature identification information, the resource corresponding to the resource obtaining request is sent to the client. In conventional technologies, because of the large number of users who are using resources, there is no effective method at present to verify identifies of access users and thereby detection of hotlinking cannot be realized. As compared with the conventional technologies, the technical solutions in embodiments of the present disclosure configure the feature identification information associated with resources to be accessed for users in advance, and perform verification when users request the resources, and thus can ensure that the users who request resources are those who really need these resources rather than those doing hotlinking. Consequently, loss of data and resources on websites and wastes of system resources can be avoided.

Further, an embodiment of the present provides a device for detecting hotlinking to implement the above method described in connection with FIG. 2. The device can be arranged in a resource server. As shown in FIG. 4, the device can include a receiving unit 41, a determination unit 42, and a sending unit 43.

The receiving unit 41 is configured to receive a resource obtaining request for obtaining a resource sent from a client. Identification information of the client is carried in the resource obtaining request.

The determination unit 42 is configured to determine whether there is feature identification information in the identification information of the client. The feature identification information is configured to indicate that there is advertising information which is associated with the resource requested by the resource obtaining request and is delivered to the client.

The sending unit 43 is configured to, if there is the feature identification information, send the resource corresponding to the resource obtaining request to the client.

Further, the sending unit 43 is further configured to, if there is not the feature identification information in the identification information of the client, send identification information of an advertisement to be delivered to the client, so that the client obtains the advertisement from an advertising system according to the identification information of the advertisement to be delivered, delivers the advertisement, and receives the feature identification information sent from the advertising system.

Further, the device can further include an outputting unit 44 and a storing unit 45.

The determination unit 42 is further configured to, when the resource obtaining request sent from the client is received, determine whether there is the feature identification information in the identification information of the client.

The outputting unit 44 is configured to, if there is not the feature identification information, output alarm information containing the identification information of the client.

The storing unit 45 is configured to store the identification information of the client in a preset blacklist.

The determination unit 42 is further configured to determine whether there is the identification information of the client in the preset blacklist.

The determination unit 42 is configured to, if there is not the identification information of the client in the preset blacklist, determine whether there is the feature identification information in the identification information of the client.

In the embodiment of the present, the feature identification information is Token.

It should be noted that the above descriptions in connection with FIG. 2 also apply to respective functional units in the device for detecting hotlinking provided in the embodiment of the present disclosure, and thus repeated description is omitted.

In the device for detecting hotlinking provided by the present disclosure, firstly, a resource obtaining request for obtaining a resource sent from a client is obtained, and identification information of the client is carried in the resource obtaining request; then, whether there is feature identification information in the identification information of the client is determined, and the feature identification information is configured to indicate that there is advertising information which is associated with the resource requested by the resource obtaining request and is delivered to the client; if there is the feature identification information, the resource corresponding to the resource obtaining request is sent to the client. In conventional technologies, because of the large number of users who are using resources, there is no effective method at present to verify identifies of access users and thereby detection of hotlinking cannot be realized. As compared with the conventional technologies, the technical solutions in embodiments of the present disclosure configure the feature identification information associated with resources to be accessed for users in advance, and perform verification when users request the resources, and thus can ensure that the users who request resources are those who really need these resources rather than those doing hotlinking. Consequently, loss of data and resources on websites and wastes of system resources can be avoided.

Further, an embodiment of the present disclosure further provides a non-transitory computer-readable storage medium storing executable instructions, which can be executed by an electronic device to perform any methods for detecting hotlinking mentioned by embodiments of the present disclosure.

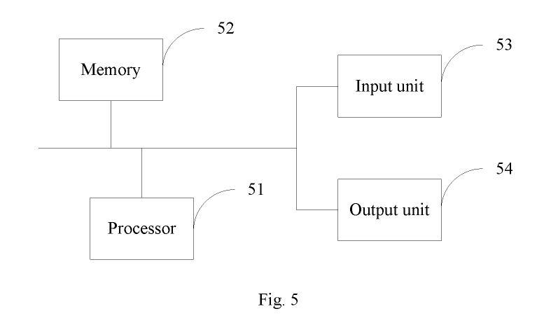

FIG. 5 is a block diagram of an electronic device which is configured to perform the methods for detecting hotlinking according to an embodiment of the present disclosure. As shown in FIG. 5, the device includes: one or more processors 51 and memory 52. A processor 51 is showed in FIG. 5 for an example.

Device which is configured to perform the methods for detecting hotlinking can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the methods for detecting hotlinking mentioned by embodiments of the present disclosure (such as shown in FIG. 3, receiving unit 31, determination unit 32, sending unit 33). Processor 51 performs kinds of functions and detecting hotlinking of the electronic device by executing non-transitory software program, instructions and modules which are stored in memory 52, thereby realizes the methods for detecting hotlinking mentioned by embodiments of the present disclosure.

Memory 52 can include program storage area and data storage area, thereby the operating system and applications required by at least one function can be stored in program storage area and data created by using the device for detecting hotlinking can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the device for detecting hotlinking by networks. The examples of said networks are including but not limited to Internet, Intranet, LAN, mobile Internet and their combinations.

Input unit 53 can be used to receive inputted number, character information and key signals causing user configures and function controls of the device for detecting hotlinking. Output unit 54 can include a display screen or a display device.

The said module or modules are stored in memory 52 and perform the methods for detecting hotlinking when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be physically separated or not, and the portions shown as respective units may be physical units or not, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platforms, or may be realized by hardware. Based on such understanding, the essence of or a part of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for detecting hotlinking, implemented by a resource server, comprising:
receiving a resource obtaining request for obtaining a resource sent from a client, wherein identification information of the client is carried in the resource obtaining request;
determining whether there is feature identification information in the identification information of the client, wherein the feature identification information is configured to indicate that there is advertising information which is associated with the resource requested by the resource obtaining request and is delivered to the client; and
if there is the feature identification information, sending the resource corresponding to the resource obtaining request to the client.

2. The method according to claim 1, wherein after the determining of whether there is feature identification information in the identification information of the client, the method further comprises:
if there is not the feature identification information in the identification information of the client, sending identification information of an advertisement to be delivered to the client, so that the client obtains the advertisement from an advertising system according to the identification information of the advertisement to be delivered, delivers the advertisement, and receives the feature identification information sent from the advertising system.

3. The method according to claim 2, wherein after the sending of the identification information of the advertisement to be delivered to the client if there is not the feature identification information in the identification information of the client, the method further comprises:
when receiving the resource obtaining request sent from the client, determining whether there is the feature identification information in the identification information of the client; and
if there is not the feature identification information, outputting alarm information containing the identification information of the client and storing the identification information of the client in a preset blacklist.

4. The method according to claim 3, wherein before the determining of whether there is feature identification information in the identification information of the client, the method further comprises:
determining whether there is the identification information of the client in the preset blacklist;
if there is not the identification information of the client in the preset blacklist, determining whether there is the feature identification information in the identification information of the client.

5. The method according to claim 1, wherein the feature identification information is Token.

6. An electronic device, comprising:
at least one processor; and
a memory communicably connected with the at least one processor for storing instructions executable by the at least one processor, wherein execution of the instructions by the at least one processor causes the at least one processor to:
receive a resource obtaining request for obtaining a resource sent from a client, wherein identification information of the client is carried in the resource obtaining request;
determine whether there is feature identification information in the identification information of the client, wherein the feature identification information is configured to indicate that there is advertising information which is associated with the resource requested by the resource obtaining request and is delivered to the client; and
if there is the feature identification information, send the resource corresponding to the resource obtaining request to the client.

7. The electronic device according to claim 6, wherein after the determining of whether there is feature identification information in the identification information of the client, wherein the instructions are executed to cause the at least one processor to:
if there is not the feature identification information in the identification information of the client, send identification information of an advertisement to be delivered to the client, so that the client obtains the advertisement from an advertising system according to the identification information of the advertisement to be delivered, delivers the advertisement, and receives the feature identification information sent from the advertising system.

8. The electronic device according to claim 7, wherein after the sending of the identification information of the advertisement to be delivered to the client if there is not the feature identification information in the identification information of the client, wherein the instructions are executed to cause the at least one processor to:
when receiving the resource obtaining request sent from the client, determine whether there is the feature identification information in the identification information of the client; and
if there is not the feature identification information, output alarm information containing the identification information of the client and store the identification information of the client in a preset blacklist.

9. The electronic device according to claim 8, wherein before the determining of whether there is feature identification information in the identification information of the client, wherein the instructions are executed to cause the at least one processor to:
determine whether there is the identification information of the client in the preset blacklist;
if there is not the identification information of the client in the preset blacklist, determine whether there is the feature identification information in the identification information of the client.

10. The electronic device according to claim 6, wherein the feature identification information is Token.

11. A non-transitory computer-readable storage medium storing executable instructions that, when executed by an electronic device, cause the electronic device to:
receive a resource obtaining request for obtaining a resource sent from a client, wherein identification information of the client is carried in the resource obtaining request;
determine whether there is feature identification information in the identification information of the client, wherein the feature identification information is configured to indicate that there is advertising information which is associated with the resource requested by the resource obtaining request and is delivered to the client; and
if there is the feature identification information, send the resource corresponding to the resource obtaining request to the client.

12. The non-transitory computer-readable storage medium according to claim 11, wherein after the determining of whether there is feature identification information in the identification information of the client, wherein the executable instructions are executed to cause the electronic device to:
if there is not the feature identification information in the identification information of the client, send identification information of an advertisement to be delivered to the client, so that the client obtains the advertisement from an advertising system according to the identification information of the advertisement to be delivered, delivers the advertisement, and receives the feature identification information sent from the advertising system.

13. The non-transitory computer-readable storage medium according to claim 12, wherein after the sending of the identification information of the advertisement to be delivered to the client if there is not the feature identification information in the identification information of the client, wherein the executable instructions are executed to cause the electronic device to:
when receiving the resource obtaining request sent from the client, determine whether there is the feature identification information in the identification information of the client; and
if there is not the feature identification information, output alarm information containing the identification information of the client and store the identification information of the client in a preset blacklist.

14. The non-transitory computer-readable storage medium according to claim 13, wherein before the determining of whether there is feature identification information in the identification information of the client, wherein the executable instructions are executed to cause the electronic device to:
determine whether there is the identification information of the client in the preset blacklist;
if there is not the identification information of the client in the preset blacklist, determine whether there is the feature identification information in the identification information of the client.

15. The non-transitory computer-readable storage medium according to claim 11, wherein the feature identification information is Token.
